(19) United States
(12) Patent Application Publication
(10) Pub. No.: US 2020/0251248 A1
(43) Pub. Date: Aug. 6, 2020

(54) COATED CARBON NANOTUBE ELECTRIC WIRE

(71) Applicant: FURUKAWA ELECTRIC CO., LTD., Tokyo (JP)

(72) Inventors: Satoshi YAMAZAKI, Tokyo (JP); Satoshi YAMASHITA, Tokyo (JP); Kenji HATAMOTO, Tokyo (JP); Hideki AIZAWA, Tokyo (JP)

(73) Assignee: FURUKAWA ELECTRIC CO., LTD., Tokyo (JP)

(21) Appl. No.: 16/857,972

(22) Filed: Apr. 24, 2020

Related U.S. Application Data
(63) Continuation of application No. PCT/JP2018/039974, filed on Oct. 26, 2018.

(30) Foreign Application Priority Data
Oct. 26, 2017 (JP) 2017-207670

(51) Int. Cl. H01B 7/08; C01B 32/168; H01B 1/04; H01B 7/42

(52) U.S. Cl. CPC H01B 7/0876; H01B 7/42; H01B 1/04; C01B 32/168

(57) ABSTRACT

The present disclosure provides a coated carbon nanotube electric wire capable of realizing an excellent insulation property, and additionally realizing excellent adhesiveness, while having excellent electroconductivity comparable to those of wires composed of copper, aluminum and the like. A coated carbon nanotube electric wire includes a carbon nanotube wire composed of a single or a plurality of carbon nanotube aggregates each constituted of a plurality of carbon nanotubes, and an insulating coating layer coating the carbon nanotube wire, wherein an arithmetic mean roughness Ra1 on a peripheral surface of the carbon nanotube wire in a longitudinal direction is larger than 0.05 μm and not larger than 16 μm, and an arithmetic mean roughness Ra2 on a peripheral surface of the carbon nanotube wire in a circumferential direction is not smaller than 0.01 μm and not larger than 4.5 μm.

### CROSS REFERENCE TO RELATED APPLICATIONS

The present application is a continuation application of International Patent Application No. PCT/JP2018/039974 filed on Oct. 26, 2018, which claims the benefit of Japanese Patent Application No. 2017-207670, filed on Oct. 26, 2017. The contents of these applications are incorporated herein by reference in their entirety.

### BACKGROUND

### Technical Field

The present disclosure relates to a coated carbon nanotube electric wire in which a carbon nanotube wire constituted of a plurality of carbon nanotubes is coated with an insulating material.

### Background

Carbon nanotubes (each hereinafter occasionally referred to as “CNT”) are material having various characteristics and promise applications to many fields.

For example, a CNT is a three-dimensional mesh structure body constituted of a single cylindrical body having a mesh structure of hexagonal lattices or of a plurality of such cylindrical bodies substantially coaxially arranged, and is light in weight and excellent in characteristics such as electroconductivity, thermoconductivity and mechanical strength. It is however difficult to form CNTs into a wire, and a technology to use CNTs as a wire has not been proposed.

As a few exemplary technologies to use a CNT line, it has been examined to use CNTs as a substitute for a metal which is a material embedded in via holes formed in a multilayer wiring structure. Specifically, in order to reduce resistance in the multilayer wiring structure, a wiring structure in which a multi-walled CNT by which a plurality of cut ends of the multi-walled CNT concentrically extending toward the end portion distal to the basal point of growth of the multi-walled CNT are caused to contact individual conductive layers is used as interlayer wiring for two or more conductive wire layers has been proposed (Japanese Patent Laid-Open No. 2006-120730).

As another example, in order to further improving electroconductivity of a CNT material, a carbon nanotube material in which an electroconductive deposit composed of a metal or the like is formed at an electric joint between adjacent CNT wires has been proposed, and it is disclosed that such a carbon nanotube material can be applied to wide purposes (Japanese Translation of PCT International Application Publication No. 2015-523944). Moreover, due to excellent thermoconductivity of a CNT wire, a heater having a heat conducting member made of a matrix of carbon nanotubes has been proposed (Japanese Patent Laid-Open No. 2015-181102).

Meanwhile, as electric power lines and signal lines in various fields of automobiles, industrial instruments and the like, electric wires composed of a core wire composed of one or a plurality of wires and an insulating coating covering the core wire are used. While as a material of the wires constituting the core wire, copper or copper alloy is typically used in view of electric characteristics, aluminum or aluminum alloy has been proposed recently in view of weight reduction. For example, the specific gravity of aluminum is about ⅓ of the specific gravity of copper, the electric conductivity of aluminum is about ⅔ of the electric conductivity of copper (pure aluminum is about 66% IACS when pure copper is the standard for 100% IACS), and while in order to cause an identical current to flow in an aluminum wire to the current for a copper wire, it is needed for the sectional area of the aluminum wire to be about 1.5 times larger than the sectional area of the wire of copper, even if an aluminum wire for which the sectional area is made large as above is used, it is advantageous to use such an aluminum wire in view of weight reduction since the mass of the aluminum wire is about a half the mass of the wire of pure copper.

Automobiles, industrial instruments and the like have been recently being made high in performance and high in functionality, and since along with such advance, the number of wires of various electric devices, control devices and the like being arranged increases and the number of wires of electric wiring bodies used for these devices and heat generation from the core wires tend to increase, it is required to improve heat dissipation characteristics of electric wires.

Meanwhile, when peeling occurs between a conductor and an insulating coating layer, partial discharge easily occurs at a gap portion between the conductor and the insulating coating layer, and since an insulation property deteriorates due to occurrence of dielectric breakdown caused by erosion of the insulating coating layer or the like, it is important to improve adhesiveness between a CNT wire which is a conductor and an insulating coating layer in order not to damage a desired insulation property. Meanwhile, in order to improve fuel consumptions of movable bodies such as automobiles for environmental compatibility, there is demand for weight reduction of wires.

### SUMMARY

The present disclosure is related to providing a coated carbon nanotube electric wire capable of realizing excellent adhesiveness, and additionally realizing weight reduction while having excellent electroconductivity comparable to those of wires composed of copper, aluminum and the like.

In accordance with one aspect of the present disclosure, a coated carbon nanotube electric wire includes a carbon nanotube wire having a single or a plurality of carbon nanotube aggregates each constituted of a plurality of carbon nanotubes, and an insulating coating layer coating the carbon nanotube wire, wherein an arithmetic mean roughness Ra1 on a peripheral surface of the carbon nanotube wire in a longitudinal direction is larger than 3.5 μm and not larger than 16 μm, and an arithmetic mean roughness Ra2 on the peripheral surface of the carbon nanotube wire in a circumferential direction is not smaller than 0.1 μm and not larger than 4.5 μm.

Moreover, it is preferable for a ratio of the arithmetic mean roughness Ra1 on the peripheral surface of the carbon nanotube wire in the longitudinal direction relative to an arithmetic mean roughness Ra3 on a peripheral surface of the carbon nanotube aggregate in a longitudinal direction to be not less than 20 and not more than 500.

Moreover, it is preferable for the ratio of the arithmetic mean roughness Ra1 on the peripheral surface of the carbon nanotube wire in the longitudinal direction relative to the arithmetic mean roughness Ra3 on the peripheral surface of the carbon nanotube aggregate in the longitudinal direction to be not less than 400 and not more than 500.

Moreover, it is preferable for a twisting number of the carbon nanotube wire composed by twisting to be not less than 1 T/m and not more than 13000 T/m. It is preferable for a twisting number of the carbon nanotube wire composed by twisting to be not less than 1 T/m and not more than 1200 T/m.

The coated carbon nanotube electric wire may further include a plating part provided in at least a portion between the carbon nanotube wire and the insulating coating layer, and a chemical modification part provided in at least a portion between the plating part and the insulating coating layer.

The plating part may be a plating layer formed across a whole peripheral surface of the carbon nanotube wire, and the chemical modification part may be formed across a whole peripheral surface of the plating layer.

It is preferable for a full-width at half maximum Δθ in azimuth angle in azimuth plot by small-angle X-ray scattering indicating orientation of the plurality of the carbon nanotube aggregates to be not larger than 60°.

It is preferable for a q value of a peak top in a (10) peak of scattering intensity by X-ray scattering indicating a density of a]the plurality of the carbon nanotubes to be not smaller than 2.0 nm⁻¹ and not larger than 5.0 nm⁻¹, and it is preferable for a full-width at half maximum Δq to be not smaller than 0.1 nm⁻¹ and not larger than 2.0 nm⁻¹.

It is preferable for a proportion of a sectional area of the insulating coating layer in a radial direction to a sectional area of the carbon nanotube wire in a radial direction to be not less than 0.001 and not more than 1.5.

It is preferable for a sectional area of the carbon nanotube wire in the radial direction to be not smaller than 0.01 mm² and not larger than 100 mm².

Being different from a metal-made core wire, the carbon nanotube wire in which carbon nanotubes are used as a core wire has anisotropy in thermal conduction, and heat is transmitted more predominantly in the longitudinal direction than in the radial direction. Namely, the carbon nanotube wire has anisotropy in heat dissipation characteristics, and hence, has more excellent heat dissipation ability than a metal-made core wire. Moreover, the carbon nanotube wire has the single or the plurality of carbon nanotube aggregates each constituted of the plurality of carbon nanotubes, and hence, being different from a wire composed of a metal, fine concavities and convexities are formed on the peripheral surface. Further, according to the present disclosure, since the arithmetic mean roughness Ra1 on the peripheral surface of the carbon nanotube wire in the longitudinal direction is larger than 3.5 μm and not larger than 16 μm, and the arithmetic mean roughness Ra2 on the peripheral surface of the carbon nanotube wire in the circumferential direction is not smaller than 0.1 μm and not larger than 4.5 μm, formation is done in the state where a part of a resin constituting the insulating coating layer enters the fine concavities and convexities formed on the peripheral surface of the carbon nanotube wire. Therefore, adhesiveness between the peripheral surface of the carbon nanotube wire and the inner circumferential surface of the insulating coating layer goes up, occurrence of peeling between the carbon nanotube wire and the insulating coating is restrained, and an excellent insulation property can be realized. Moreover, more weight reduction can be realized than that for a coated electric wire in which a conductor made of a metal such as copper and aluminum is coated, along with excellent electroconductivity comparable to a wire composed of copper, aluminum and the like.

Moreover, by the ratio of the arithmetic mean roughness Ra1 on the peripheral surface of the carbon nanotube wire in the longitudinal direction relative to the arithmetic mean roughness Ra3 on the peripheral surface of the carbon nanotube aggregate in the longitudinal direction being not less than 20 and not more than 500, adhesiveness between the peripheral surface of the CNT wire and the inner circumferential surface of the insulating coating layer can be further improved. Moreover, it is preferable for the ratio Ra1/Ra3 to be not less than 400 and not more than 500 in view of peeling improvement.

Moreover, by the coated carbon nanotube electric wire further including the plating part provided in at least a portion between the carbon nanotube wire and the insulating coating layer, and the chemical modification part provided in at least a portion between the plating part and the insulating coating layer, moderate concavities and convexities are formed on the peripheral surface of the plating part by the chemical modification part, and an excellent insulation property can be maintained while preventing deterioration of adhesiveness between the plating part and the insulating coating layer.

Moreover, by the full-width at half maximum Δθ in azimuth angle in azimuth plot by small-angle X-ray scattering on the carbon nanotube aggregates in the carbon nanotube wire being not larger than 60°, the carbon nanotubes and the carbon nanotube aggregates have high orientation in the carbon nanotube wire, heat generated in the carbon nanotube wire is scarcely transmitted to the insulating coating layer, and heat dissipation characteristics further goes up.

Moreover, by the q value of the peak top in the (10) peak of scattering intensity by X-ray scattering on the arranged carbon nanotubes being not smaller than 2.0 nm⁻¹ and not larger than 5.0 nm⁻¹ and the full-width at half maximum Δq being not smaller than 0.1 nm⁻¹ and not larger than 2.0 nm⁻¹, the carbon nanotubes can exist with a high density, heat generated in the carbon nanotube wire is further scarcely transmitted to the insulating coating layer, and heat dissipation characteristics further goes up.

Furthermore, by the proportion of the sectional area of the insulating coating layer in the radial direction to the sectional area of the carbon nanotube wire in the radial direction being not less than 0.001 and not more than 1.5, even when a thin insulating coating layer, which easily causes thickness deviation, is formed, further weight reduction can be realized without damaging an insulation property.

### BRIEF DESCRIPTION OF THE DRAWINGS

FIG. 1 is an explanatory view of a coated carbon nanotube electric wire according to an embodiment of the present disclosure.

FIG. 2 is an explanatory view of a carbon nanotube wire used for a coated carbon nanotube electric wire according to an embodiment of the present disclosure.

FIG. 3A is a diagram exemplarily showing a two-dimensional scattering image of scattering vectors q of a plurality of carbon nanotube aggregates by SAXS, and FIG. 3B is a graph exemplarily showing an azimuth angle to scattering intensity of any scattering vector q with the position of a transmitted X-ray being as an original in the two-dimensional scattering image.

FIG. 4 is a graph showing relation between a q value and intensity by WAXS of a plurality of carbon nanotubes constituting a carbon nanotube aggregate.

FIGS. 5A and 5B are cross-sectional views showing modifications of the coated carbon nanotube electric wire in FIG. 1.

### DETAILED DESCRIPTION

Hereinafter, coated carbon nanotube electric wires according to embodiments of the present disclosure will be described with reference to the accompanying drawings.

### [Configuration of Coated Carbon Nanotube Electric Wire]

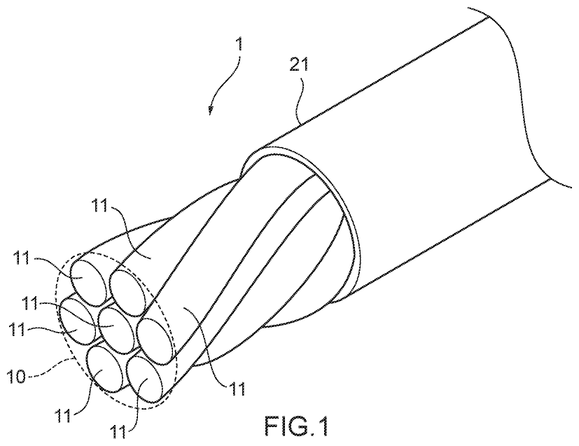

As shown in FIG. 1, a coated carbon nanotube electric wire 1 according to an embodiment of the present disclosure (hereinafter occasionally referred to as “coated CNT electric wire”) has a configuration in which a peripheral surface of a carbon nanotube wire (hereinafter occasionally referred to as “CNT wire”) 10 is coated with an insulating coating layer 21. Namely, coating with the insulating coating layer 21 is done along a longitudinal direction of the CNT wire 10. In the coated CNT electric wire 1, the whole peripheral surface of the CNT wire 10 is coated with the insulating coating layer 21. Moreover, in the coated CNT electric wire 1, the insulating coating layer 21 is in a mode of directly contacting the peripheral surface of the CNT wire 10. While in FIG. 1, the CNT wire 10 is an element wire (single wire) composed of one CNT wire 10, the CNT wire 10 may be in a state of a twisted wire obtained by twisting a plurality of CNT wires 10 together at a predetermined twisting number. By bringing the CNT wire 10 into a form of a twisted wire, an equivalent circle diameter and/or a sectional area of the CNT wire 10 can be properly adjusted.

In a metal electric wire such as a copper electric wire, unit lattices form each grain aggregate with each unit lattice being as a minimum unit, and grain aggregates combine to form a conductor. In the metal electric wire, although thermal conduction in a radial direction is disturbed at grain boundaries between the grain aggregates, this contribution is small. In the metal electric wire, it is therefore considered that heat dissipation ability is defined mainly caused by a degree of concavities and convexities on the surface of the metal electric wire and the heat dissipation ability goes up when the surface of the metal electric wire is rough and the concavities and convexities are large.

On the other hand, the CNT wire 10 is formed by CNTs 11a mentioned later gathering, and each CNT 11a is a nanowire in which a diameter is about 1.0 nm to 5.0 nm and an aspect ratio between the diameter and a length is about 2000 to 20000. Moreover, it can also be a case where the CNT wire 10 forms a CNT wire 10 in which the CNTs 11a take a hexagonal close packed structure and are twisted together. Since heat generated by passing electricity through the CNT wire 10 is generated at defect portions of the CNTs 11a, 11a, . . . , the heat is generated without regard to the CNTs 11a being at a center or an outside. In particular, heat inside the CNTs 11a is not transmitted in the radial direction unless the CNTs 11a or CNT aggregates 11 contact one another.

Accordingly, heat dissipation ability of the CNT wire 10 is defined mainly based on a balance between a degree of concavities and convexities on the surface of the CNT wire 10 and a degree of close contact between the CNTs 11a or the CNT aggregates 11. It is considered from the above that the CNT wire 10 in a form of a twisted wire further improves the heat dissipation ability of the CNT wire 10 as a twisting number is higher in the case where an arithmetic mean roughness (Ra) of the CNT wire 10 is identical. Note that when the metal electric wire is set to be a twisted wire, it cannot be twisted by setting a twisting number to be as high as in the CNT wire 10, in view of mechanical strength and the like.

Taking account of the aforementioned principles of heat dissipation ability, a twisting number in the case of setting the CNT wire 10 to be a twisted wire can be properly set to be within a range to achieve the effects of the present disclosure. It is preferable for the twisting number in the case of setting the CNT wire 10 to be a twisted wire to be not less than 1 T/m and not more than 13000 T/m. Moreover, in view of the heat dissipation ability and peeling resistance, it is preferable for the twisting number in the case of setting the CNT wire 10 to be a twisted wire to be not less than 1 (T/m) and not more than 13000 (T/m), still preferable to be not less than 1200 (T/m), still preferable to be not less than 8000 (T/m) and not more than 10000 (T/m), and further preferable to be 9000 (T/m).

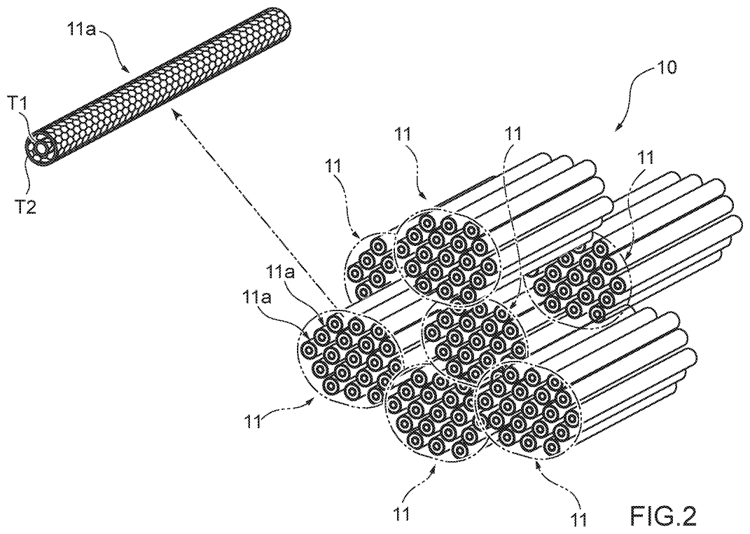

As shown in FIG. 2, the CNT wire 10 is formed of a single carbon nanotube aggregate (hereinafter occasionally referred to as “CNT aggregate”) 11 constituted of a plurality of CNTs 11a, 11a, . . . each having a wall structure with one or more walls, or by a plurality of carbon nanotube aggregates 11 being bundled. Herein, the CNT wire means a CNT wire in which a ratio of CNTs is 90 mass % or more. Note that plating and dopants are excluded from calculation of the CNT proportion in the CNT wire. Each CNT aggregate 11 is linear, and the plurality of CNT aggregates 11, 11, . . . in the CNT wire 10 are arranged such that longitudinal axis directions of the CNT aggregates 11 are substantially uniform. Accordingly, the plurality of CNT aggregates 11, 11, . . . in the CNT wire 10 are oriented. An equivalent circle diameter of the CNT wire 10 which is a twisted wire is not specially limited and is exemplarily not smaller than 0.1 mm and not larger than 15 mm.

The CNT aggregate 11 is a bundle of CNTs 11a each having a wall structure with one or more walls. Longitudinal directions of the CNTs 11a form a longitudinal direction of the CNT aggregate 11. The plurality of CNTs 11a, 11a, . . . in the CNT aggregate 11 are arranged such that longitudinal axis directions of the CNTs 11a are substantially uniform. Accordingly, the plurality of CNTs 11a, 11a, . . . in the CNT aggregate 11 are oriented. An equivalent circle diameter of the CNT aggregate 11 is exemplarily not smaller than 20 nm and not larger than 1000 nm, more typically not smaller than 20 nm and not larger than 80 nm. A width dimension of the outermost wall of the CNT 11a is exemplarily not smaller than 1.0 nm and not larger than 5.0 nm.

Each of the CNTs 11a constituting the CNT aggregate 11 is a cylindrical body having any of a single-walled structure and a multi-walled structure which are called a SWNT (single-walled nanotube) and a MWNT (multi-walled nanotube), respectively. While in FIG. 2, only CNTs 11a having double-walled structures are presented for convenience, CNTs each having a wall structure having a structure with three or more walls and/or CNTs each having a wall structure having a structure with a single wall may also be contained in the CNT aggregate 11, which may be formed of CNTs each having a wall structure having a structure with three or more walls or CNTs each having a wall structure having a structure with a single wall.

The CNT 11a having a double-walled structure is a three-dimensional mesh structure body in which two cylindrical bodies T1 and T2 each having a mesh structure with hexagonal lattices are substantially coaxially arranged, and is called a DWNT (double-walled nanotube). Each of the hexagonal lattices which are structure units is a six-membered ring at the vertices of which carbon atoms are arranged, and these are continuously connected such that one six-membered ring is adjacent to another.

Nature of the CNTs 11a depends on chiralities of the aforementioned cylindrical bodies. The chiralities are roughly categorized into an armchair form, a zigzag form and a chiral form, the armchair form exhibits behavior of metal nature, the zigzag form exhibits behavior of semiconductor nature and semimetal nature, and the chiral form exhibits behavior of semiconductor nature and semimetal nature. Accordingly, electroconductivity of the CNT 11a largely changes depending on which chirality the cylindrical body has. In each of the CNT aggregates 11 constituting the CNT wire 10 of the coated CNT electric wire 1, it is preferably to increase a proportion of the CNTs 11a in the armchair form exhibiting the behavior of metal nature in view of further improving the electroconductivity.

Meanwhile, it is found that the CNTs 11a in the chiral form exhibiting the behavior of semiconductor nature are to exhibit the metallic behavior by doping the CNTs 11a in the chiral form with a substance (heteroelement) having electron donating nature or electron accepting nature. Moreover, for a general metal, dispersion of conduction electrons occurs inside the metal due to doping with a heteroelement and electroconductivity decreases. Likewise, when doping the CNT 11a exhibiting the behavior of metal nature with a heteroelement, such decrease in electroconductivity occurs.

Since effects of doping the CNT 11a exhibiting the behavior of metal nature and the CNT 11a exhibiting the behavior of semiconductor nature are in tradeoff relation as above in view of electroconductivity, it is theoretically desirable to separately prepare the CNTs 11a exhibiting the behavior of metal nature and the CNTs 11a exhibiting the behavior of semiconductor nature, to perform a doping treatment only on the CNTs 11a exhibiting the behavior of semiconductor nature, and after that, to combine both of them. It is nevertheless difficult to selectively separately prepare the CNTs 11a exhibiting the behavior of metal nature and the CNTs 11a exhibiting the behavior of semiconductor nature by any of current production technologies, and the CNTs 11a exhibiting the behavior of metal nature and the CNTs 11a exhibiting the behavior of semiconductor nature are prepared in the state where they are mixed. Therefore, in order to further improve electroconductivity of the CNT wire 10 composed of a mixture of the CNTs 11a exhibiting the behavior of metal nature and the CNTs 11a exhibiting the behavior of semiconductor nature, it is preferable to select wall structures of the CNTs 11a by which a doping treatment with a heteroelement/molecule is effective.

For example, a CNT with a small number of walls as in the double-walled structure or the triple-walled structure has relatively higher electroconductivity than a CNT with a larger number of walls, and when the doping treatment is performed, the effect of doping for the CNT having the double-walled structure or the triple-walled structure is highest. It is accordingly preferable to increase a proportion of CNTs having the double-walled structure or the triple-walled structure in view of further improving the electroconductivity of the CNT wire 10. Specifically, it is preferable for the proportion of CNTs having the double-walled structure or the triple-walled structure to the whole CNTs to be not less than 50% in number, and still preferably to be not less than 75% in number. The proportion of CNTs having the double-walled structure or the triple-walled structure can be calculated by observing and analyzing a cross section of the CNT aggregate 11 with a transmission electron microscope (TEM), selecting any CNTs in predetermined number within a range of 50 to 200, and measuring the number of walls for each of the CNTs.

Next, orientation of the CNTs 11a and the CNT aggregates 11 in the CNT wire 10 is described.

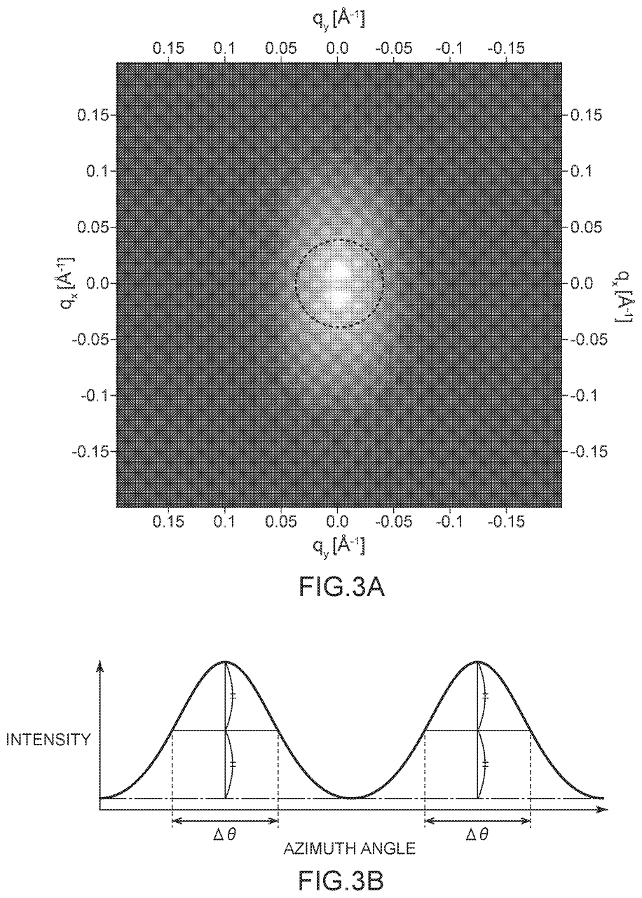

FIG. 3A is a diagram exemplarily showing a two-dimensional scattering image of scattering vectors q of a plurality of CNT aggregates 11, 11, . . . by small-angle X-ray scattering (SAXS), and FIG. 3B is a graph exemplarily showing an azimuth plot showing relation between an azimuth angle and scattering intensity of any scattering vector q with the position of a transmitted X-ray being as an original in the two-dimensional scattering image.

The SAXS is suitable for evaluating a structure and the like with a size of nanometers to tens of nanometers. For example, by analyzing information of an X-ray scattering image by the following method using the SAXS, orientation of the CNTs 11a outer diameters of which are nanometers, and orientation of the CNT aggregates 11 outer diameters of which are tens of nanometers can be evaluated. For example, when an X-ray scattering image is analyzed on the CNT wire 10, as shown in FIG. 3A, q_{y} which is a y-component of a scattering vector q (q=2π/d where d is a lattice spacing) of the CNT aggregate 11 is distributed to be narrower than qₓ which is an x-component of the scattering vector q. Moreover, a full-width at half maximum Δθ in azimuth angle in azimuth plot shown in FIG. 3B as a result of analyzing the azimuth plot by the SAXS on the CNT wire 10 identical to that in FIG. 3A is 48°. It can be said from these analysis results that the plurality of CNTs 11a, 11a, . . . and the plurality of CNT aggregates 11, 11, . . . have excellent orientation in the CNT wire 10. Heat of the CNT wire 10 can be easily dissipated while being smoothly transmitted along the longitudinal directions of the plurality of CNTs 11a and the plurality of CNT aggregates 11 since the CNTs 11a, 11a, . . . and the CNT aggregates 11, 11, . . . have such excellent orientation as above. The CNT wire 10 accordingly achieves more excellent heat dissipation characteristics than a metal-made core wire since a heat dissipation route can be adjusted over the longitudinal direction and a radial, sectional direction by adjusting the aforementioned orientation of the CNTs 11a and the CNT aggregates 11. Note that orientation here represents angular differences of vectors of CNTs and CNT aggregates inside relative to a vector V, in a longitudinal direction, of a twisted wire prepared by collecting and twisting CNTs together.

In view of further improving heat dissipation characteristics of the CNT wire 10 by obtaining orientation indicated by a full-width at half maximum Δθ in azimuth angle in azimuth plot by small-angle X-ray scattering (SAXS) indicating orientation of the plurality of CNT aggregates 11, 11, . . . , in a specific level or higher, it is preferable for a full-width at half maximum Δθ in azimuth angle to be not larger than 60°, and particularly preferable to be not smaller than 15°.

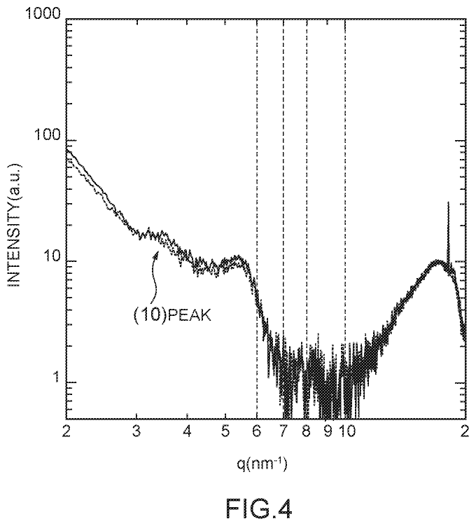

WAXS is suitable for evaluating a structure and the like of a substance with a size not larger than nanometers. For example, by analyzing information of an X-ray scattering image by the following method using WAXS, a density of the CNTs 11a the outer diameters of which are not larger than nanometers can be evaluated. As shown in FIG. 4 as a result of analyzing relation between the scattering vector q and intensity on any one CNT aggregate 11, a value of a lattice constant estimated from a q value of the peak top of a (10) peak shown approximately at q=3.0 nm⁻¹ to 4.0 nm⁻¹ is measured. It can be examined, based on this measurement value of the lattice constant and a diameter of the CNT aggregate observed by Raman spectroscopy, TEM or the like, that the CNTs 11a, 11a, . . . form a hexagonal close packed structure in plane view. It can be accordingly said that a diameter distribution of the plurality of CNT aggregates in the CNT wire 10 is narrow, and the plurality of CNTs 11a, 11a, . . . are arranged with regularity, that is, have a high density, and thereby, form a hexagonal close packed structure to exist with such a high density.

As above, heat of the CNT wire 10 can be easily dissipated while being smoothly transmitted along the longitudinal directions of the CNT aggregates 11 since the plurality of CNT aggregates 11, 11, . . . have excellent orientation, and furthermore, the plurality of CNTs 11a, 11a, . . . constituting the CNT aggregates 11 are arranged with regularity to be arranged with a high density. Accordingly, the CNT wire 10 achieves more excellent heat dissipation characteristics than a metal-made core wire since a heat dissipation route can be adjusted over the longitudinal direction and the radial, sectional direction by adjusting an arrangement structure and a density of the aforementioned CNT aggregates 11 and CNTs 11a.

In view of further improving heat dissipation characteristics by obtaining a high density, it is preferable for the q value of the peak top in the (10) peak of intensity by X-ray scattering indicating a density of the plurality of CNTs 11a, 11a, . . . to be not smaller than 2.0 nm⁻¹ and not larger than 5.0 nm⁻¹, and for a full-width at half maximum Δq (FWHM) to be not smaller than 0.1 nm⁻¹ and not larger than 2.0 nm⁻¹.

The orientation of the CNT aggregates 11 and the CNTs 11a, and the arrangement structure and the density of the CNTs 11a can be adjusted by properly selecting a spinning method such as dry spinning and wet spinning, and spinning conditions for the spinning method mentioned later.

Next, the insulating coating layer 21 covering the external surface of the CNT wire 10 is described.

As a material of the insulating coating layer 21, a material used for an insulating coating layer of a coated electric wire with a metal used as a core wire can be used, and, for example, a thermoplastic resin can be cited. As the thermoplastic resin, for example, polytetrafluoroethylene (PTFE), polyethylene, polypropylene, polyacetal, polystyrene, polycarbonate, polyamide, polyvinyl chloride, polyvinyl acetate, polyurethane, polymethyl methacrylate, an acrylonitrile butadiene styrene resin, an acrylic resin and the like can be cited. One of these may be solely used, or two or more kinds of these may be properly mixed and used.

The insulating coating layer 21 may be set to be one layer as shown in FIG. 1, or may include two or more layers instead. For example, the insulating coating layer may have a first insulating coating layer formed on a periphery of the CNT wire 10, and a second insulating coating layer formed on a periphery of the first insulating coating layer. Moreover, the aforementioned thermosetting resin constituting the insulating coating layer 21 may contain filler in a form of fibers or a form of particles. Moreover, one or two or more layers of thermosetting resin may be further provided on the insulating coating layer 21 as needed. Moreover, the aforementioned thermosetting resin may contain filler in a form of fibers or a form of particles.

In the coated CNT electric wire 1, a proportion of a sectional area of the insulating coating layer 21 in a radial direction to a sectional area of the CNT wire 10 in the radial direction is within a range not less than 0.001 and not more than 1.5. Since a core wire is the CNT wire 10 lighter in weight than copper, aluminum and the like and a thickness of the insulating coating layer 21 can be made small due to the proportion of the sectional area being within the range not less than 0.001 and not more than 1.5, heat dissipation characteristics of the CNT wire 10 excellent on heat can be obtained while sufficiently securing insulation reliability. Moreover, even if a thick insulating coating layer is formed, more weight reduction can be realized than in the case of a coated electric wire made of a metal such as copper and aluminum.

Moreover, while it can be a case where solely with the CNT wire 10, shape maintenance in the longitudinal direction is difficult, by the external surface of the CNT wire 10 being coated with the insulating coating layer 21 at the proportion of the sectional area, the coated CNT electric wire 1 can maintain a shape in the longitudinal direction. Accordingly, handling ability in routing the coated CNT electric wire 1 can be enhanced.

The proportion of the sectional area is not specially limited as long as it is within a range not less than 0.001 and not more than 1.5 but a lower limit value of the proportion of the sectional area is preferably 0.1, particularly preferably 0.2, in view of further improving insulation reliability. An upper limit value of the proportion of the sectional area is preferably 1.0, particularly preferably 0.5, in view of further weight reduction of the coated CNT electric wire 1 and further improving heat dissipation characteristics of the CNT wire 10 on heat.

When the proportion of the sectional area is within a range not less than 0.001 and not more than 1.5, the sectional area of the CNT wire 10 in the radial direction is exemplarily preferably not smaller than 0.01 mm² and not larger than 100 mm², still preferably not smaller than 0.01 mm² and not larger than 15 mm², particularly preferably not smaller than 0.03 mm² and not larger than 6.0 mm². Moreover, the sectional area of the insulating coating layer 21 in the radial direction is exemplarily preferably not smaller than 0.003 mm² and not larger than 40 mm², particularly preferably not smaller than 0.03 mm² and not larger than 8 mm², in view of an insulation property and heat dissipation ability. The sectional area of the insulating coating layer 21 in the radial direction also includes that of resin entering gaps in the CNT wire 10.

The sectional areas can be measured, for example, from an image of scanning electron microscope (SEM) observation. Specifically, after obtaining a SEM image (at a magnification from 100 to 10,000) of a cross section of the coated CNT electric wire 1 in the radial direction, an area obtained by subtracting an area of a material of the insulating coating layer 21 entering the inside of the CNT wire 10 from an area of a portion enclosed by a periphery of the CNT wire 10, and a total of an area of a portion of the insulating coating layer 21 which the periphery of the CNT wire 10 is coated with and the area of the material of the insulating coating layer 21 entering the inside of the CNT wire 10 are set to be the sectional area of the CNT wire 10 in the radial direction and the sectional area of the insulating coating layer 21 in the radial direction, respectively. The sectional area of the insulating coating layer 21 in the radial direction also contains the resin entering gaps in the CNT wires 10.

In the coated CNT electric wire 1, an arithmetic mean roughness Ra1 on the peripheral surface of the CNT wire 10 in the longitudinal direction is larger than 3.5 μm and not larger than 16 μm. Moreover, in the coated CNT electric wire 1, it is preferable for an arithmetic mean roughness Ra2 on the peripheral surface of the CNT wire 10 in a circumferential direction to be not smaller than 0.1 μm and not larger than 4.5 μm. Note that, in the present specification, the “peripheral surface of the CNT wire 10” indicates the outermost surface which defines the outer edge of the CNT wire 10 in the radial direction. When the arithmetic mean roughness Ra1 on the peripheral surface of the CNT wire 10 in the longitudinal direction is larger than 16 μm or the arithmetic mean roughness Ra2 on the peripheral surface of the CNT wire 10 in the circumferential direction is larger than 4.5 μm, adhesiveness decreases since concavities and convexities formed on the peripheral surface of the CNT wire 10 are too large.

The arithmetic mean roughness Ra1 of the CNT wire 10 in the longitudinal direction and the arithmetic mean roughness Ra2 of the CNT wire 10 in the circumferential direction depend on the twisting number (T/m: the number of twists per meter), for example, of CNT wire 10, and the arithmetic mean roughness Ra1 of the CNT wire 10 in the longitudinal direction is smaller as the twisting number is smaller and is larger as the twisting number is larger. Moreover, the arithmetic mean roughness Ra2 of the CNT wire 10 in the circumferential direction has a tendency to be larger as the twisting number is smaller and to be smaller as the twisting number is larger. Accordingly, in the coated CNT electric wire 1, the twisting number of the CNT wire 10 can be adjusted such that both the arithmetic mean roughness Ra1 of the CNT wire 10 in the longitudinal direction and the arithmetic mean roughness Ra2 of the CNT wire 10 in the circumferential direction are values respectively within the aforementioned ranges.

By the arithmetic mean roughness Ra1 on the peripheral surface of the CNT wire 10 in the longitudinal direction being not smaller than 3.5 μm and not larger than 16 μm and the arithmetic mean roughness Ra2 on the peripheral surface of the CNT wire 10 in the circumferential direction being not smaller than 0.01 μm and not larger than 4.5 μm as above, the coated CNT electric wire 1 is formed in a state where a part of the resin constituting the insulating coating layer 21 enters fine concavities and convexities formed on the peripheral surface of the CNT wire 10.

Here, when having prepared one wire having an identical outer diameter to that of the CNT wire 10 with a metal such as aluminum and copper, concavities and convexities are scarcely formed on a peripheral surface of the metal-made wire, an arithmetic mean roughness on the peripheral surface of the aluminum-made wire or the copper-made wire in a longitudinal direction and an arithmetic mean roughness on the peripheral surface in a circumferential direction are smaller than the arithmetic mean roughnesses Ra1 and Ra2 of the CNT wire 10, and it is not possible for a part of a resin constituting an insulating coating layer to enter concavities and convexities on the peripheral surface of the metal-made wire.

On the other hand, in the coated CNT electric wire 1, in a step of forming the insulating coating layer 21, a part of the resin constituting the insulating coating layer 21 can enter fine concavities and convexities formed on the peripheral surface of the CNT wire 10. Accordingly, adhesiveness between the peripheral surface of the CNT wire 10 and an inner circumferential surface of the insulating coating layer 21 goes up, occurrence of peeling between the CNT wire 10 and the insulating coating 21 is restrained, and an excellent insulation property can be realized.

A ratio of the arithmetic mean roughness Ra1 on the peripheral surface of the CNT wire 10 in the longitudinal direction relative to an arithmetic mean roughness Ra3 on a peripheral surface of the CNT aggregate 11 in the longitudinal direction is not specially limited but preferably not less than 20 and not more than 500 in view of further improving the adhesiveness between the peripheral surface of the CNT wire 10 and the inner circumferential surface of the insulating coating layer 21. Moreover, the ratio Ra1/Ra3 is preferably not less than 400 in view of improvement of peeling. The arithmetic mean roughness Ra3 on the peripheral surface of the CNT aggregate 11 in the longitudinal direction is exemplarily 0.001 um to 0.2 μm, preferably a value close to substantially zero, for example, 0.001 μm to 0.04 μm.

The arithmetic mean roughnesses Ra1 and Ra2 of the CNT wire 10 can be nondestructively measured. They can be calculated, for example, by observing a plurality of SEM images while changing the angle of a sample stage to create a surface three-dimensional image. Moreover, as to the arithmetic mean roughness Ra3 on the peripheral surface of the CNT aggregate 11 in the longitudinal direction, the roughness can be calculated, for example, through SEM observation from a lateral surface. Each of Ra1, Ra2 and Ra3 can be measured based on values obtained by properly using an atomic force microscope (AFM), a SEM and a laser microscope in accordance with a target to be measured.

Moreover, while it can be a case where solely with the CNT wire 10, shape maintenance in the longitudinal direction is difficult, by the external surface of the CNT wire 10 being coated with the insulating coating layer 21 at the aforementioned proportion of the sectional area, the coated CNT electric wire 1 can maintain a shape in the longitudinal direction, and deformation processing such as bending processing is easy. Accordingly, the coated CNT electric wire 1 can be formed into a shape along a desired wiring route.

It is preferably for a thickness of the insulating coating layer 21 in the perpendicular direction (that is, the radial direction) to the longitudinal direction to be uniform in view of improving an insulation property and abrasion resistance of the coated CNT electric wire 1. Specifically, it is preferably for a thickness deviation rate of the insulating coating layer 21 to be not less than 50% in view of improving the insulation property and the abrasion resistance, and moreover, preferably to be not less than 70% in view of improving handling ability in addition to these. Note that, in the present specification, the “thickness deviation rate” means a value obtained by calculating each value of α=(the minimum value of the thickness of the insulating coating layer 21/the maximum value of the thickness of the insulating coating layer 21) ×100 for each of radial directional cross sections of the coated CNT electric wire 1 at every 10 cm for any 1.0 m of the coated CNT electric wire 1 in the longitudinal direction, and averaging the a values calculated for the individual cross sections. Moreover, the thickness of the insulating coating layer 21 can be measured, for example, from an image of SEM observation by approximating the CNT wire 10 with a circle. Herein, a longitudinal directional center side indicates a region, of the wire, positioned in a center portion as seen through the longitudinal direction.

The thickness deviation rate of the insulating coating layer 21 can be caused to go up, for example, by adjusting tensile force exerted on the CNT wire 10 in the longitudinal direction during the CNT wire 10 being caused to pass through a dice in an extrusion step in the case of forming the insulating coating layer 21 on the peripheral surface of the CNT wire 10 by extrusion coating.

Moreover, while in the aforementioned embodiment, the insulating coating layer 21 directly contacts the peripheral surface of the CNT wire 10 in the coated CNT electric wire 1, not limited to this, it does not have to directly contact the peripheral surface of the CNT wire 10.

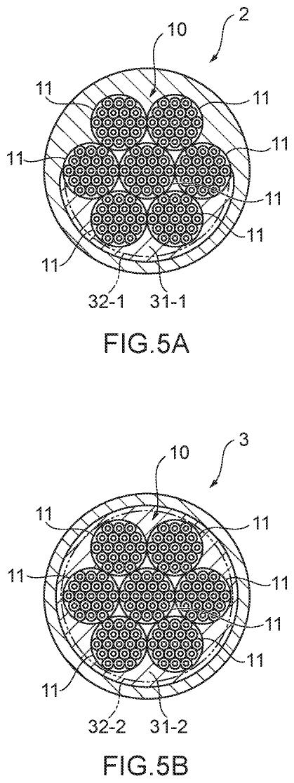

For example, as shown in FIG. 5A, a coated CNT electric wire 2 may include a plating part 31-1 provided in at least a portion between the CNT wire 10 and the insulating coating layer 21, and a chemical modificationpart 32-1 provided in at least a portion between the plating part 31-1 and the insulating coating layer 21.

The plating part 31-1 is formed, for example, on a part of the peripheral surface of the CNT wire 10, and in the present embodiment, is formed in a portion corresponding to a semicircular arc of the peripheral surface of the CNT wire in a radial directional cross section of the CNT wire 10. For plating constituting the plating part 31-1, for example, one or a plurality of materials selected from a group consisting of metals such as gold, silver, copper, platinum, zinc, iron, lead, tin, aluminum, cobalt, indium, nickel, chromium, titanium, antimony, bismuth, germanium, cadmium and silicon can be cited. One of these metals may be solely used or two or more of these may be used. By the plating part 31-1 being provided between the CNT wire 10 and the insulating coating layer 21 as above, plating enters fine concavities and convexities on the peripheral surface of the CNT wire 10, and concavities and convexities relatively smaller than the concavities and convexities on the peripheral surface of the CNT wire 10 are formed on a peripheral surface of the plating part 31-1.

The chemical modificationpart 32-1 is a site having a concave and convex surface (also called roughened surface) formed on the peripheral surface of the plating part 31-1, for example, through a chemical treatment, and by the chemical modificationpart 32-1 being formed on the peripheral surface of the plating part 31-1, the chemical modificationpart 32-1 is provided between the plating part 31-1 and the insulating coating layer 21. By the chemical modificationpart 32-1 being provided between the plating part 31-1 and the insulating coating layer 21 as above, moderate concavities and convexities can be formed on the peripheral surface of the plating part 31-1, and an excellent insulation property can be maintained while preventing decrease in adhesiveness between the plating part 31-1 and the insulating coating layer 21.

The chemical treatment for forming the chemical modificationpart 32-1 can be performed, for example, using a chemical modifier.

Moreover, as shown in FIG. 5B, in a coated CNT electric wire 3, a plating part 31-2 may be a plating layer formed across the whole peripheral surface of the CNT wire 10, and a chemical modification part 32-2 may be formed across the whole peripheral surface of the plating part 31-2. Thereby, an excellent insulation property can be maintained while preventing decrease in adhesiveness between the plating part 31-2 and the insulating coating layer 21, across the whole peripheral surface of the plating part 31-2.

### [Method for Manufacturing Coated Carbon Nanotube Electric Wire]

Next, an exemplary method for manufacturing the coated CNT electric wire 1 according to an embodiment of the present disclosure is described. The coated CNT electric wire 1 can be manufactured by first manufacturing the CNTs 11a, forming the CNT wire 10 from the obtained plurality of CNTs 11a, and coating the peripheral surface of the CNT wire 10 with the insulating coating layer 21.

The CNTs 11a can be prepared by a technique such as a floating catalyst method (Japanese Patent No. 5819888) and a substrate method (Japanese Patent No. 5590603). An element wire of the CNT wire 10 can be prepared, for example, by dry spinning (Japanese Patent No. 5819888, Japanese Patent No. 5990202 or Japanese Patent No. 5350635), wet spinning (Japanese Patent No. 5135620, Japanese Patent No. 5131571 or Japanese Patent No. 5288359), liquid crystal spinning (Japanese Translation of PCT International Application Publication No. 2014-530964), or the like.

In this stage, the orientation of CNT aggregates constituting the CNT wire 10 and the orientation of CNTs constituting the CNT aggregate, or the densities of the CNT aggregates 11 and the CNTs 11a can be adjusted, for example, by properly selecting a spinning method such as the dry spinning, the wet spinning and the liquid crystal spinning, and spinning conditions of the spinning method.

For a method of coating the peripheral surface of the CNT wire 10 obtained as above with the insulating coating layer 21, a method of coating a core wire of aluminum or copper with an insulating coating layer can be used, and, for example, a method of melting a thermoplastic resin which is a row material of the insulating coating layer 21 and extruding it onto the periphery of the CNT wire 10 to perform coating, or a method of applying the thermoplastic resin onto the periphery of the CNT wire 10 can be cited.

The coated CNT electric wire 1 according to an embodiment of the present disclosure can be used as a general electric wire such as a wire harness, and a cable may be prepared from such a general electric wire for which the coated CNT electric wire 1 is used.

### EXAMPLES

Next, examples of the present disclosure will be described, meaning no limitation to the examples themselves below as long as not departing from the spirit of the present disclosure.

### Examples 1 to 26 and Comparative Examples 1 to 4

Method for Manufacturing CNT Wire

First, element wires (single wires) for CNT wires having sectional areas as presented in Table 1 were obtained by a dry spinning method by which methods CNTs prepared by the floating catalyst method were directly spun (Japanese Patent No. 5819888) or a method of wet spinning (Japanese Patent No. 5135620, Japanese Patent No. 5131571 or Japanese Patent No. 5288359). Moreover, for each of twisted wires, the number of CNT wires each having a predetermined equivalent circle diameter was adjusted to properly twist the CNT wires together, the twisted wire being obtained to have a sectional area as presented in Table 1.

Method for Coating External Surface of CNT Wire with Insulating Coating Layer Extrusion coating was performed on the periphery of conductor using a typical extrusion machine for electric wire manufacturing with any of the following resins to prepare coated CNT electric wires used for the examples and the comparative examples presented in Table 1 below.

Polyimide: U-Imide made by UNITIKA Ltd.

Polypropylene: NOVATEC-PP made by Japan Polypropylene Corporation

(a) Measurement of Sectional Area of CNT Wire

After cutting was performed to afford a cross section in a radial direction of a CNT wire by an ion milling system (IM4000, Hitachi High-Technologies Corporation), a sectional area of the CNT wire in the radial direction was measured from a SEM image obtained with a scanning electron microscope (SU8020, Hitachi High-Technologies Corporation, Magnification: 100 to 10,000). Similar measurements were repeated at every 10 cm for any 1.0 m of a coated CNT electric wire on a longitudinal directional center side, and an average value of those was set to be the sectional area of the CNT wire in the radial direction. Note that, for the sectional area of the CNT wire, a resin entering the inside of the CNT wire was excluded from the measurement.

(b) Measurement of Sectional Area of Insulating Coating Layer

After cutting was performed to afford a cross section in the radial direction of a CNT wire by an ion milling system (IM4000, Hitachi High-Technologies Corporation), a sectional area of an insulating coating layer in the radial direction was measured from a SEM image obtained with a scanning electron microscope (SU8020, Hitachi High-Technologies Corporation, Magnification: 100 to 10,000). Similar measurements were repeated at every 10 cm for any 1.0 m of the coated CNT electric wire 1 in a longitudinal direction, and an average value of those was set to be the sectional area of the insulating coating layer in the radial direction. Accordingly, for the sectional area of the insulating coating layer, the resin entering inside of the CNT wire was also included in the measurement.

(c) Measurement of Full-Width at Half Maximum Δθ in Azimuth Angle by SAXS X-ray scattering measurement was performed using a small-angle X-ray scattering device (Aichi Synchrotron), and from an azimuth plot obtained, a full-width at half maximum Δθ in azimuth angle was obtained.

(d) Measurement of q Value at Peak Top and Full-Width at Half Maximum Δq by WAXS

Wide-angle X-ray scattering measurement was performed using a wide-angle X-ray scattering device (Aichi Synchrotron), and from a q value-intensity graph obtained, a q value of the peak top and a full-width at half maximum Δq in a (10) peak of intensity were obtained.

(e) Measurements of Arithmetic Mean Roughness Ra1 in Longitudinal Direction and Arithmetic Mean Roughness Ra2 in Circumferential Direction on Peripheral Surface of CNT Wire and Measurement of Arithmetic Mean Roughness Ra3 on Peripheral Surface of CNT Aggregate in Longitudinal Direction

Information of a surface shape of the CNT wire was acquired using three types of devices of an atomic force microscope (AFM), a SEM and a laser microscope. Based on the information obtained, the arithmetic mean roughnesses Ra1, Ra2 and Ra3 were calculated.

Results of the measurements above for the coated carbon nanotube electric wires are presented in Table 1 below.

Evaluations below were performed for the coated carbon nanotube electric wires prepared as above.

(1) Measurement of Twisting Number of CNT Wire

In the case of a twisted wire, a plurality of single wires were bundled, and one end of those was twisted a predetermined number of times in the state where the other end was fixed, thereby affording the twisted wire. A twisting number is represented by a value (unit: T/m) having the number of times of twists (T) divided by a length of the wire (m).

(2) Heat Dissipation Ability (Longitudinal Direction) of Coated CNT Electric Wire

Resistance measurement was performed by a four-terminal method with four terminals connected to both ends of 100 cm of coated CNT electric wire. In this stage, an applied current was set to be 2000 A/cm², and a change-over-time of a resistance value was recorded. Resistance values at the start of measurement and after the elapse of 10 minutes were compared, and an increase rate between them was calculated. Since a CNT electric wire increases in resistance in proportion to a temperature, it can be determined that heat dissipation ability is more excellent as the increase rate in resistance is smaller. The increase rate in resistance lower than 5% was set to be Good, that not lower than 5% and lower than 10% was to be Fair, and that not lower than 10% was to be Poor.

It should be noted that since for a different conductor, a correlation coefficient between the temperature and the increase in resistance is different, the CNT electric wires were not able to be compared with a copper electric wire and the like by this evaluation method, and evaluation on the copper electric wire and the like was not performed.

(3) Adhesiveness

A coated CNT electric wire was pinched by a mandrel with 12 mm of diameter, a weight with 1 kg of weight was hung on the CNT strand wire, which was bent rightward and leftward each by 90 degrees (totally 180 degrees).

No peeling observed on the insulating coating layer from the coated CNT electric wire after a bending test of 100 thousand times was regarded as being passed “Good”, and observation of peeling was regarded as not being passed “Poor”.

(4) Peeling Resistance

Different from (3), T-peel test was performed for evaluating adhesiveness between a CNT wire and an insulating coating layer. A notch was cut in a section of a coated carbon nanotube electric wire at one end portion in the longitudinal direction, one side in the longitudinal direction was set to have a structure of the CNT wire and the insulating coating layer, the other side was set to have a structure only of the insulating coating layer, these structures were pulled upward and downward, respectively, and strength was examined. At 1 cm/min of pulling speed, peeling stress was determined based on load when peeling happened, and was evaluated as follows.

The peeling stress within a range of 100 MPa to 70 MPa was regarded as “Excellent”, that within a range of 70 MPa to 40 MPa was regarded as “Good”, that within a range of 40 MPa to 1 MPa was regarded as “Fair”, and that within a range lower than 1 MPa was regarded as “Poor”.

(5) Insulation Reliability

A method in conformity with Article 13.3 of JIS C 3215-0-1 was performed. A test result satisfying Grade 3 described in Table 9 was set to be Excellent, that satisfying Grade 2 was set to be Good, that satisfying Grade 1 was set to be Fair, and that not satisfying any grade was set to be Poor.

The results of the evaluations above are presented in Table 1 below.

TABLE 1

| | | | | Sectional | | | |
|---|---|---|---|---|---|---|---|
| | | | | Area of | | Ra1 on | Ra2 on |
| | | | | Insulating | | Peripheral | Peripheral |
| | | | | Coating | | Surface of | Surface of |
| | | Sectional | Sectional | Layer/ | | Carbon | Carbon |
| | Type of | Area of | Area of | Sectional | | Nanotube | Nanotube |
| | Resin of | Carbon | Insulating | Area of | | Wire in | Wire in |
| | Insulating | Nanotube | Coating | Carbon | | Longitudinal | Radial |
| | Coating | Wire | Layer | Nanotube | Twists | Direction | Direction |
| | Layer | (mm²) | (mm²) | Wire | (T/m) | (μm) | (μm) |
| Example 1 | Polyimide | 0.035 | 0.0245 | 0.7 | 0 | 3.6 | 0.3 |
| Example 2 | | 0.934 | 0.8873 | 0.95 | 0 | 4.2 | 0.5 |
| Example 3 | | 3.110 | 2.4258 | 0.78 | 0 | 4.3 | 2.2 |
| Example 4 | | 0.035 | 0.0245 | 0.7 | 40 | 3.7 | 0.3 |
| Example 5 | | 0.934 | 0.8873 | 0.95 | 40 | 5.2 | 0.5 |
| Example 6 | | 3.110 | 2.4258 | 0.78 | 40 | 10.5 | 4.3 |
| Example 7 | | 0.035 | 0.0245 | 0.7 | 100 | 3.8 | 1.1 |
| Example 8 | | 0.934 | 0.8873 | 0.95 | 100 | 6.8 | 3.1 |
| Example 9 | | 3.110 | 2.4258 | 0.78 | 100 | 15 | 4.5 |
| Example 10 | | 10.569 | 7.50399 | 0.71 | 750 | 13.4 | 3.8 |
| Example 11 | | 35.680 | 29.6144 | 0.83 | 1800 | 11.9 | 4.1 |
| Example 12 | | 60.210 | 46.3617 | 0.77 | 9000 | 16 | 4.5 |
| Example 13 | | 80.320 | 65.0592 | 0.81 | 10000 | 14.2 | 4.2 |
| Example 14 | Polypropylene | 0.035 | 0.0245 | 0.7 | 0 | 3.6 | 0.3 |
| Example 15 | | 0.934 | 0.6071 | 0.65 | 0 | 3.8 | 0.5 |
| Example 16 | | 11.000 | 8.58 | 0.78 | 0 | 4.3 | 2.2 |
| Example 17 | | 0.035 | 0.0245 | 0.7 | 40 | 4 | 0.3 |
| Example 18 | | 0.934 | 0.6071 | 0.65 | 40 | 5.2 | 0.5 |
| Example 19 | | 11.000 | 8.58 | 0.78 | 40 | 10.5 | 4.3 |
| Example 20 | | 0.035 | 0.0245 | 0.7 | 100 | 4.4 | 1.1 |
| Example 21 | | 0.934 | 0.6071 | 0.65 | 100 | 5.2 | 3.1 |
| Example 22 | | 11.000 | 8.58 | 0.78 | 100 | 15 | 4.5 |
| Example 23 | | 10.569 | 7.50399 | 0.71 | 750 | 13.4 | 3.8 |
| Example 24 | | 35.680 | 29.6144 | 0.83 | 1800 | 11.9 | 4.1 |
| Example 25 | | 60.210 | 46.3617 | 0.77 | 9000 | 16 | 4.5 |
| Example 26 | | 80.320 | 65.0592 | 0.81 | 10000 | 14.2 | 4.2 |
| Comparative | Polyimide | 0.934 | 0.8873 | 0.95 | 40 | 1.8 | 0.5 |
| Example 1 | | | | | | | |
| Comparative | | 0.934 | 0.8873 | 0.95 | 40 | 1.2 | 5 |
| Example 2 | | | | | | | |
| Comparative | Polypropylene | 0.934 | 0.8873 | 0.95 | 40 | 2 | 0.5 |
| Example 3 | | | | | | | |
| Comparative | | 0.934 | 0.8873 | 0.95 | 40 | 1.2 | 7 |
| Example 4 | | | | | | | |

| | Ra3 on | | | | | |
|---|---|---|---|---|---|---|
| | Peripheral | | | | | |
| | Surface of | | | | | |
| | Carbon | | | | | |
| | Nanotube | | Heat | | | |
| | Aggregate in | | Dissipation | | | |
| | Longitudinal | | Ability in | | | |
| | Direction | | Longitudinal | | Peeling | Insulation |
| | (μm) | Ra1/Ra3 | Direction | Adhesiveness | Resistance | Reliability |
| Example 1 | 0.01 | 360.00 | Good | Good | Good | Good |
| Example 2 | 0.18 | 23.33 | Good | Fair | Fair | Good |
| Example 3 | 0.04 | 107.50 | Good | Good | Good | Good |
| Example 4 | 0.01 | 370.00 | Good | Good | Good | Good |
| Example 5 | 0.012 | 433.33 | Fair | Excellent | Excellent | Fair |
| Example 6 | 0.025 | 420.00 | Fair | Excellent | Excellent | Fair |
| Example 7 | 0.01 | 380.00 | Good | Good | Good | Fair |
| Example 8 | 0.02 | 340.00 | Fair | Good | Good | Fair |
| Example 9 | 0.033 | 454.55 | Fair | Excellent | Excellent | Fair |
| Example 10 | 0.06 | 223.33 | Fair | Good | Good | Fair |
| Example 11 | 0.14 | 85.00 | Good | Fair | Good | Fair |
| Example 12 | 0.032 | 500.00 | Excellent | Excellent | Excellent | Fair |
| Example 13 | 0.16 | 88.75 | Excellent | Fair | Good | Fair |
| Example 14 | 0.01 | 360.00 | Good | Good | Good | Good |
| Example 15 | 0.13 | 29.23 | Good | Good | Fair | Good |
| Example 16 | 0.033 | 130.30 | Good | Good | Good | Good |
| Example 17 | 0.01 | 400.00 | Good | Good | Excellent | Good |
| Example 18 | 0.012 | 433.33 | Fair | Good | Excellent | Fair |
| Example 19 | 0.033 | 318.18 | Fair | Excellent | Excellent | Fair |
| Example 20 | 0.01 | 440.00 | Good | Good | Excellent | Fair |
| Example 21 | 0.012 | 433.33 | Fair | Good | Excellent | Fair |
| Example 22 | 0.033 | 454.55 | Fair | Excellent | Excellent | Fair |
| Example 23 | 0.06 | 223.33 | Fair | Good | Good | Fair |
| Example 24 | 0.14 | 85.00 | Good | Fair | Good | Fair |
| Example 25 | 0.032 | 500.00 | Excellent | Excellent | Excellent | Fair |
| Example 26 | 0.16 | 88.75 | Excellent | Fair | Good | Fair |
| Comparative | 0.5 | 3.60 | Fair | Poor | Poor | Good |
| Example 1 | | | | | | |
| Comparative | 0.12 | 10.00 | Fair | Poor | Poor | Good |
| Example 2 | | | | | | |
| Comparative | 0.4 | 5.00 | Fair | Poor | Poor | Good |
| Example 3 | | | | | | |
| Comparative | 0.12 | 10.00 | Fair | Poor | Poor | Good |
| Example 4 | | | | | | |

Note:
The underlines and italics in the table indicate that they are beyond the range of the present disclosure.

As shown in Table 1 above, in each of Examples 1 to 18, the arithmetic mean roughness Ra1 on the peripheral surface of the CNT wire in the longitudinal direction was larger than 3.5 μm and not large than 16 μm, the arithmetic mean roughness Ra2 on the peripheral surface on the CNT wire in the circumferential direction was not smaller than 0.1 μm and not larger than 4.5 μm, and any of the heat dissipation ability in the longitudinal direction, the adhesiveness, and the insulation reliability was substantially good to excellent. Moreover, in each of Examples 19 to 26, the arithmetic mean roughness Ra1 on the peripheral surface of the CNT wire in the longitudinal direction was larger than 3.5 μm and not larger than 16 μm, the arithmetic mean roughness Ra2 on the peripheral surface of the CNT wire in the circumferential direction was not smaller than 0.1 um and not larger than 4.5 μm, and any of the heat dissipation ability in the longitudinal direction, the adhesiveness, and the insulation reliability was substantially good to excellent.

Furthermore, in each of Examples 1 to 26, the full-width at half maximum Δθ in azimuth angle was not larger than 60°. Accordingly, in the CNT wires of Examples 1 to 26, the CNT aggregates had excellent orientation. Furthermore, in each of Examples 1 to 26, the q value of the peak top in the (10) peak of intensity was not smaller than 2.0 nm⁻¹ and not larger than 5.0 nm⁻¹, and the full-width at half maximum Δq was not smaller than 0.1 nm⁻¹ and not larger than 2.0 nm⁻¹. Accordingly, in the CNT wires of Examples 1 to 26, CNTs existed with high densities.

On the other hand, in each of Comparative Examples 1 and 3, the arithmetic mean roughness Ra1 on the peripheral surface of the CNT wire in the longitudinal direction was larger than 16 μm, and the adhesiveness was poor. In each of Comparative Examples 2 and 4, the arithmetic mean roughness Ra2 on the peripheral surface of the CNT wire in the circumferential direction was larger than 4.5 μm, and the adhesiveness was poor.

What is claimed is:

1. A coated carbon nanotube electric wire comprising:
a carbon nanotube wire having a single or a plurality of carbon nanotube aggregates each constituted of a plurality of carbon nanotubes; and
an insulating coating layer coating the carbon nanotube wire, wherein
an arithmetic mean roughness Ra1 on a peripheral surface of the carbon nanotube wire in a longitudinal direction is larger than 3.5 μm and not larger than 16 μm, and an arithmetic mean roughness Ra2 on the peripheral surface of the carbon nanotube wire in a circumferential direction is not smaller than 0.1 μm and not larger than 4.5 μm.

2. The coated carbon nanotube electric wire according to claim 1, wherein a ratio of the arithmetic mean roughness Ra1 on the peripheral surface of the carbon nanotube wire in the longitudinal direction relative to an arithmetic mean roughness Ra3 on a peripheral surface of the carbon nanotube aggregate in a longitudinal direction is not less than 20 and not more than 500.

3. The coated carbon nanotube electric wire according to claim 2, wherein the ratio of the arithmetic mean roughness Ra1 on the peripheral surface of the carbon nanotube wire in the longitudinal direction relative to the arithmetic mean roughness Ra3 on the peripheral surface of the carbon nanotube aggregate in the longitudinal direction is not less than 400 and not more than 500.

4. The coated carbon nanotube electric wire according to claim 1, wherein a twisting number of the carbon nanotube wire composed by twisting is not less than 1 T/m and not more than 13000 T/m.

5. The coated carbon nanotube electric wire according to claim 1, wherein a twisting number of the carbon nanotube wire composed by twisting is not less than 1 T/m and not more than 1200 T/m.

6. The coated carbon nanotube electric wire according to claim 1, further comprising:
a plating part provided in at least a portion between the carbon nanotube wire and the insulating coating layer; and
a chemical modification part provided in at least a portion between the plating part and the insulating coating layer.

7. The coated carbon nanotube electric wire according to claim 6, wherein
the plating part is a plating layer formed across a whole peripheral surface of the carbon nanotube wire, and
the chemical modification part is formed across a whole peripheral surface of the plating layer.

8. The coated carbon nanotube electric wire according to claim 1, wherein a full-width at half maximum Δθ in azimuth angle in azimuth plot by small-angle X-ray scattering indicating orientation of the plurality of the carbon nanotube aggregates is not larger than 60°.

9. The coated carbon nanotube electric wire according to claim 1, wherein a q value of a peak top in a (10) peak of scattering intensity by X-ray scattering indicating a density of the plurality of the carbon nanotubes is not smaller than 2.0 nm⁻¹ and not larger than 5.0 nm⁻¹, and a full-width at half maximum Δq is not smaller than 0.1 nm⁻¹ and not larger than 2.0 nm⁻¹.

10. The coated carbon nanotube electric wire according to claim 1, wherein a proportion of a sectional area of the insulating coating layer in a radial direction to a sectional area of the carbon nanotube wire in a radial direction is not less than 0.001 and not more than 1.5.

11. The coated carbon nanotube electric wire according to claim 8, wherein the sectional area of the carbon nanotube wire in the radial direction is not smaller than 0.01 mm² and not larger than 100 mm².
